(19) United States
(12) Patent Application Publication
(10) Pub. No.: US 2016/0316319 A1
(43) Pub. Date: Oct. 27, 2016

(54) DRIVER CELLULAR TELEPHONE TEXT AND EMAIL AUTOMATIC DEACTIVATION SYSTEM AND METHOD

(71) Applicant: Dean A. Craine, Bellevue, WA (US)

(72) Inventor: Dean A. Craine, Bellevue, WA (US)

(21) Appl. No.: 15/201,595

(22) Filed: Jul. 4, 2016

Related U.S. Application Data
(63) Continuation-in-part of application No. 13/715,890, filed on Dec. 14, 2012, now Pat. No. 9,386,142.

(51) Int. Cl. H04W 4/00; H04W 4/14

(52) U.S. Cl. CPC H04W 4/008; H04W 4/14

(57) ABSTRACT

A system and method of automatically prevents a cellular telephone operated by a driver from receiving or transmitting text and email messages while driving a motor vehicle. The system includes a first Bluetooth transceiver located inside a motor vehicle that is configured to create a link, such as a piconet, with a compatible second Bluetooth receiver located in the cellular telephone that has text and email messaging capabilities. The cellular telephone includes a software program loaded into its memory designed to automatically disable the device's text and mail messaging capabilities when the link is created. Upon entering and starting the motor vehicle, the link is established, which automatically blocks or deactivates the device's transmission and receiving message capabilities. In one embodiment, the software program provides a menu page that allows the driver to selectively turn ON or OFF different features when the two transceivers are linked. Access to the menu page may be controlled by passwords, or finger prints, or iris detection.

This is a continuation in part application based on U.S. utility patent application (Application No. 13/715/890) filed on Dec. 12, 2012, now U.S. Pat. No. 9,386,142, which is based on and claims the priority filing date benefit of U.S. provisional patent application (Application No. 61570404) filed on Dec. 14, 2011.

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention:

This invention pertains to systems or devices on portable electronic devices that limit the device's functionality when operated in an environment or location that requires the user's constant attention.

2. Description of the Related Art:

Many states have passed laws preventing drivers from surfing the web and sending and receiving text or email messages while driving. The purpose of these laws is to reduce drive distraction believed to cause a large number of motor vehicle accidents. In spite of fact that violators of these laws must pay large fines, many drivers ignore these laws and continue to search the web and send and receive text and email messages while driving. Because operating an electronic device in a motor vehicle is difficult to detect, law enforcement personnel find it difficult to find violating drivers.

Many motor vehicles have Bluetooth transmitters and receivers (hereinafter called Bluetooth transceivers) located inside the passenger compartments that can be linked to the smart keys and other Bluetooth transceivers located in cellular telephones and other devices commonly carried by a driver of a motor vehicle. Some motor vehicle Bluetooth transceivers are directly coupled or built into the motor vehicle's audio entertainment system, while others are aftermarket Bluetooth transceivers that selectively mounted onto a visor located over the driver or built into a GPS navigation and traffic device mounted on the dashboard. Such devices allow the driver to send and receive telephone calls in a ‘hands free’ manner via their cellular telephones.

Bluetooth transceivers in two devices must be linked to ‘paired’ in order to communicate. When paired, a piconet is created between them that remains activate so long as the transceivers are activated and operated within a transmission range (typically 30 feet). Once paired, the two transceivers will automatically reconnect when activated and moved within the transmission range. Today, most drivers will ‘pair’ the Bluetooth transceiver in their cellular telephone to the motor vehicle's Bluetooth transceiver so that each time the driver enters the motor vehicle with the cellular telephone, the transceivers are automatically linked together.

What is needed is a system and method of temporarily preventing the surfing of the web or the transmission and receipt of text and email messages when the electronic device that is normally configured to surf the web and to transmit and receive text and email messages, is activated and located in a motor vehicle with a Bluetooth transceiver.

### SUMMARY OF THE INVENTION

It is an object of the present invention to provide a system and method of automatically preventing the web surfing and text and email transmission capabilities of a Bluetooth enabled electronic device controlled or operated by a driver when the electronic device is located inside a motor vehicle.

The system includes a Bluetooth transceiver located inside a motor vehicle configured to create a Bluetooth piconet with a Bluetooth-enabled electronic device, such as a ‘smart’ cellular telephone, a MP3 player, a tablet computer or a laptop computer. It should be understood that such devices may include any electronic device with a Bluetooth transceiver that requires the review of visually information and the inputting of manual or verbal instructions when operating. Upon entering the motor vehicle, a link, such as a piconet, is automatically setup between the motor vehicle's Bluetooth transceiver and the Bluetooth transceiver located or coupled to the electronic device. When linked together, the system may be setup to automatically disable all voice and data telephone communications with the electronic device or it may be setup up to automatically disable some voice and data telephone communications and allow the transmission and receipt of voice and data communications from a specific list of callers or senders. The system also may be setup to allow the driver to make and receive telephone calls in a ‘hands-free’ manner using the motor vehicle's Bluetooth transceiver, but disable the SMS and MMS text services and email service while driving.

More specifically, the communication device includes a software program loaded into the electronic device's memory that discontinues the device's voice and data communication capabilities and/or the device's audio file playback and/or recording features that can be distracting to a driver when driving. In one embodiment, a triggering or blocking signal is generated when a piconet is created between the Bluetooth-enabled electronic device and the motor vehicle's Bluetooth transceiver and changes the device's operating state. In one embodiment, the software program presents a menu page that allows the driver or his or her guardian to setup different features that may be automatically disabled or limited on the electronic device when the piconet is created. Access to the menu page may be controlled by authorized user's passwords, finger print identification or iris identification.

### DESCRIPTION OF THE DRAWINGS

FIG. 1 is an illustration of a driver of a motor vehicle with a Bluetooth transceiver linked to a cellular telephone, held in the driver's hand.

FIG. 2 is an illustration of showing a motor vehicle's Bluetooth transceiver and cellular telephone's Bluetooth transceiver being linked together with a software program loaded into the memory of the cellular telephone that is configured to disable the telephone's text/email message functionality with the transceiver's are linked.

FIG. 3 is an illustration of a cellular telephone with a menu page presented on its display with a sliding ON or OFF button.

FIG. 4 is an illustration of a cellular telephone with a setup menu page presented on its display that includes buttons that enable the user to select when the system is activated, manually, continuously, or only when a piconet is detected.

FIG. 5 is an illustration of a cellular telephone with an exception menu page presented on its display that enables the user to indicated telephone numbers and email addresses from which text and email messages can be received and sent when the system is activated.

FIG. 6 is an illustration of a cellular telephone with a enter password menu page that is presented to the user before the activation menu page, the system setup menu page, and the exception pages are presented.

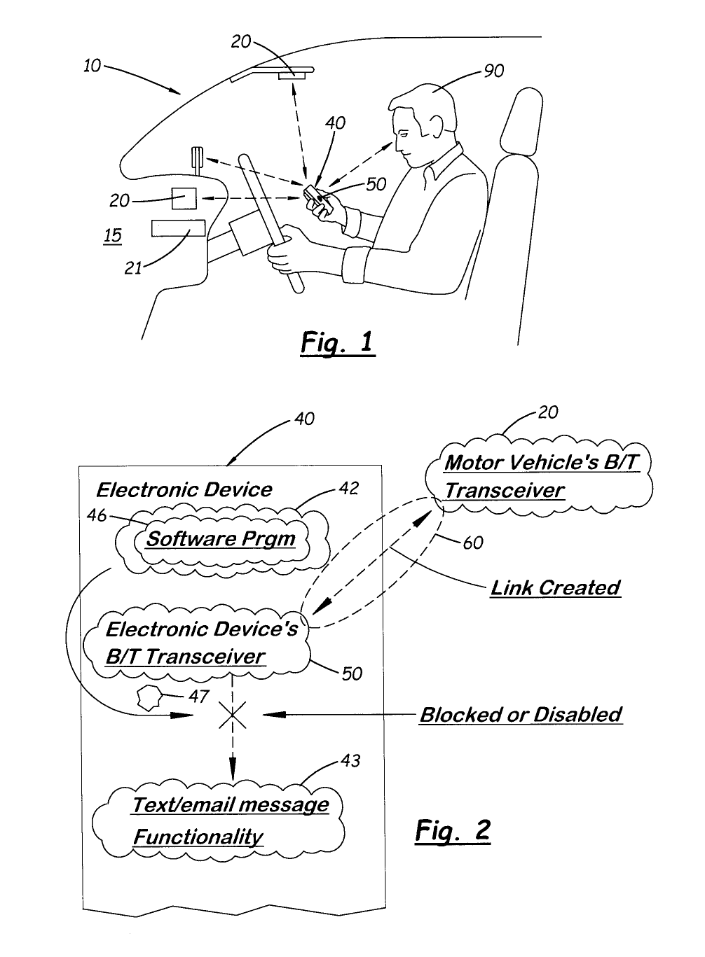

### DESCRIPTION OF THE PREFERRED EMBODIMENT(S)

Referring to the accompanying Figs. there is shown a system 10 and method that automatically prevents a cellular telephone 40 operated by a driver 90 from receiving or transmitting text and email messages while driving a motor vehicle 15. The system 10 includes a first Bluetooth transceiver 20 located inside a motor vehicle 15 configured to create a Bluetooth piconet 60 with the Bluetooth transceiver 50 in a Bluetooth enabled cellular telephone 40 with text and email messaging capabilities when the electronic device 40 is operating in the vicinity of the motor vehicle 15. Upon entering the motor vehicle 15, a piconet 60 is automatically setup between the motor vehicle's Bluetooth transceiver, hereinafter known as the first Bluetooth transceiver 20, and the cellular telephone's Bluetooth transceiver, hereinafter known as the second Bluetooth transceiver 50. In the first embodiment, the cellular telephone 40 includes working memory 42 and a software program 46 is loaded into the device's working memory 42 that blocks or deactivates the cellular telephone's text messaging and email messaging capabilities, generally indicated by the reference number 43, when a piconet 60 is created between the first and second Bluetooth transceivers 20 and 50. The software program 46 is similar to the ‘Do Not Disturb’ feature found on Apple, Inc.'s recently released IOS 6 operating program used with its popular cellular telephones. The ‘Do Not Disturb’ feature enables users to manually control or time control when telephone calls or text messages, or email messages are received on the cellular telephone. The electrical components and the software programs enable a user to selectively control when text and email messages are received by the cellular telephone.

One drawback with the ‘Do Not Distrub’ feature found in IOS 6, is that the feature is activated only when the cellular telephone is in sleep mode. If the cellular telephone remains active, the ‘Do Not Distrub’ feature is deactivated and cellular telephone continues to receive telephone calls and text and email messages.

The software program 46 is designed to allow users to manually activate the system 10, to activate the system 10 only when a piconet 60 is generated, or to activate the system 10 automatically when the cellular telephone 40 is activated. The middle and latter options may be especially important to parents concerned about teenage drivers reading and texting messages while driving. By setting up the teenager's cellular telephone 40 so the system 10 is always activated or activated when ever a piconet 60 is created with the family's motor vehicle, the text and email messaging via the teenager's cellular telephone 40 is automatically blocked or deactivated.

When initially setting up the system 10, the software program 46 creates a setup menu page 70 presented on the electronic device's display 41. On the setup menu page 70, the user may select different software controlled operations. Setup menu page 70 may include a general ON/OFF slide button 72. The general ON/OFF Slide button 72 may be on a separate page. When the slide button 72 is moved to the ON position, a second function button 74 may be used that allows the user to select if the program 46 is activated continuously or activated only when a piconet 60 is detected. A third function button 102 may be presented that enables the user to select whether selected text and mail messages may be received or sent from and to selected senders and recipients. For example, if a parent wanted to send an urgent text or email message to the teenager driver, then the parent would list her telephone number or email address in the selected senders and recipients list.

To prevent unauthorized individuals from changing the settings on the setup menu page 70, the setup menu page 70 could include password entry boxes that present the setup menu page 70 buttons only upon submission of the correct password, finger print identification or iris identification. In some instances, the setup menu page 70 may be coupled or linked to a user account setup on the cellular telephone 40 that assigns different privileges to the user. For example, the user could be listed as an administrator giving the user unlimited privileges or a standard user allowing the user to use the system by not change the cellular telephone's Bluetooth settings or when the software program is activated or deactivated.

When a piconet 60 is created between the first and second Bluetooth transceivers 20, 40, respectively, the software program 46 generates a signal 47 that blocks or deactivates the receipt and transmission of text and email messages from the cellular telephone 40. In one embodiment, the signal 47 temporarily blocks or deactivates the device's SMS and MMS service or blocks or deactivates the device's email accounts saved on the cellular telephone 40. For example, the incoming, POP3 mail server could be blocked or deactivated, or the outgoing, SMTP, mail service may be blocked or deactivated. When the piconet 60 is no longer detected, (i.e. if the motor vehicle 15 is turned off or the cellular telephone 40 is removed from the transmission range so that the piconet 60 is no longer created, the blocking signal 47 is discontinued because the software program is automatically closed or programmed to no longer produce the blocking signal 47. When the blocking signal 47 is discontinued, the electronic device's text and email message capabilities 43 return to their original state.

It should be understood that the cellular telephone 40 may be Bluetooth enabled cellular telephone, a Bluetooth enabled MP3 player, a Bluetooth enabled tablet computer or a Bluetooth enabled laptop computer. Because most drivers pair the second Bluetooth transceivers 50 in their cellular telephones 40 to the first Bluetooth transceivers 20 in the motor vehicles 15 to make and receive hands free telephone calls or to transmit audio signals from the electronic device 50 to the motor vehicle's entertainment system 21, the system 10 will automatically discontinue text and message service while driving. Because other electronic devices operated by other passengers are not paired with the first Bluetooth receiver 20, their electronic devices will continue to operate in a normal manner and receive and transmit text and email messages.

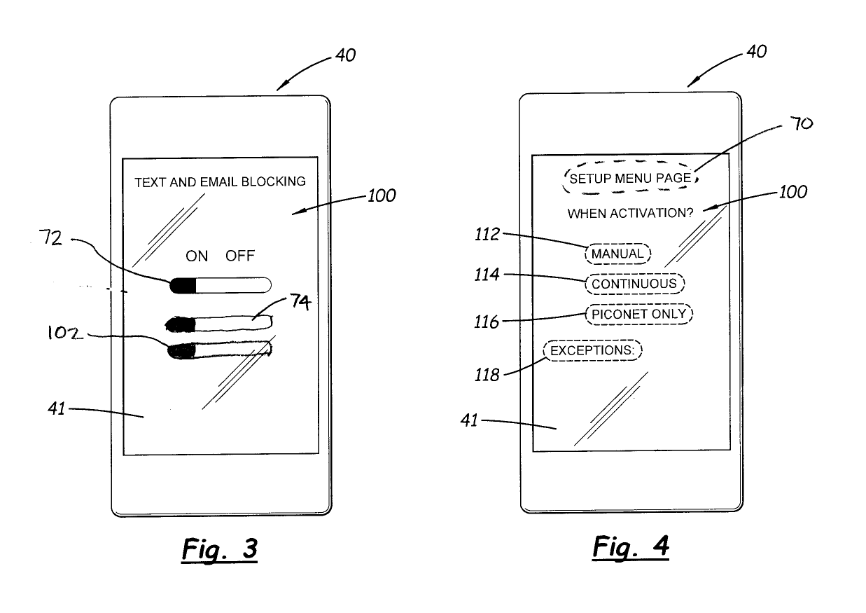

FIG. 3 is an illustration of a cellular telephone 40 with an activation menu page 100 on its display 41 with a sliding ON or OFF button 102 that turns the system 10 ON or OFF.

FIG. 4 is an illustration of a cellular telephone with a setup menu page 110 on its display 41 that includes buttons 112, 114, 116, and 118 that enable the user to select when the system is activated, manually, continuously, or only when a piconet is detected and whether exceptions are allowed, respectively.

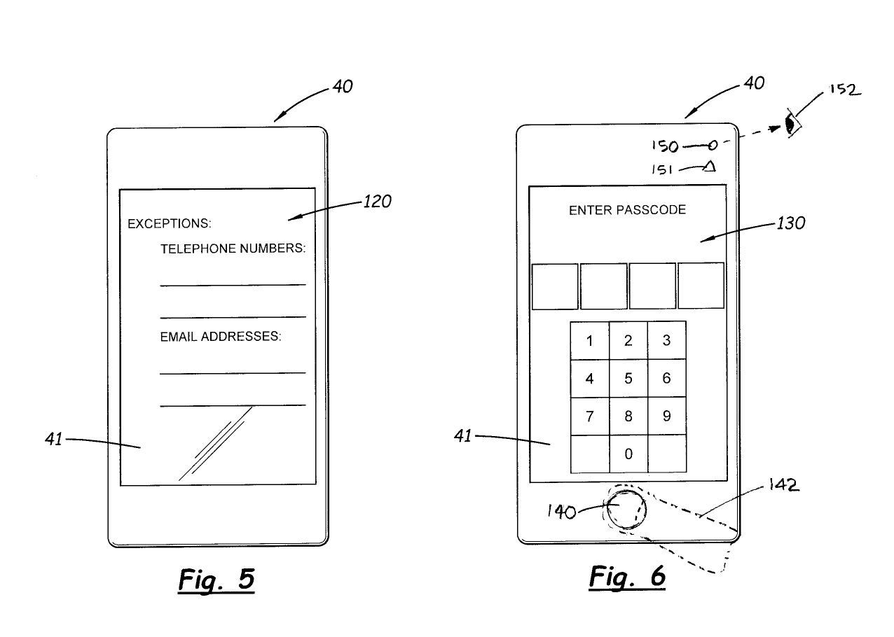

FIG. 5 is an illustration of a cellular telephone 40 with an exception menu page 120 on its display 21 that enables the user to indicated telephone numbers and email addresses from which text and email messages can be received and sent when the system 10 is activated.

FIG. 6 is an illustration of a cellular telephone 40 with a enter password menu page 130, and a finger print input area 140 and a camera lens 150. The input area 140 is linked to a finger print recognition software program 141 and the camera lens 150 is linked to an iris identification software program 151. When the proper password code, an authorized finger print is identified or an iris is identified, the activation menu page 100, the system setup menu page 70, and the exception page menu 120 are then presented.

Using the above system, a method for discontinuing the receipt or transmission of text to and from a cellular telephone configured to communicate with a nearby wireless communication network while driving a motor vehicle, comprising the following steps:

a. selecting a motor vehicle with a first Bluetooth transceiver located therein, said Bluetooth transceiver configured to communicate with a second Bluetooth transceiver in a cellular telephone when the cellular telephone is in the vicinity of the first Bluetooth receiver and automatically create a piconet between the first Bluetooth transceiver and the second Bluetooth transceiver;

b. selecting an activated cellular telephone with text message communication capabilities, the cellular telephone includes a second Bluetooth transceiver adapted to automatically create a piconet with a first Bluetooth transceiver when the cellular telephone is in the vicinity of the first Bluetooth transceiver, the cellular telephone also includes a software program that automatically blocks or deactivates the text message communication capabilities of the cellular telephone with a piconet is created between the first Bluetooth receiver and the second Bluetooth receiver;

c. transporting the cellular telephone into the motor vehicle to be driven by a user of the cellular telephone; and,

d. activating the motor vehicle and the first Bluetooth transceiver thereby automatically creating a piconet between the first Bluetooth transceiver and the second Bluetooth transceiver, and blocking or deactivating the text message communication capabilities on the cellular telephone.

I claim:

1. A portable cellular telephone configured to automatically discontinue the receipt and transmission of text or email messages over a wireless network when driving a motor vehicle equip with a first Bluetooth transceiver, the electronic device, comprising:
a. a second Bluetooth transceiver located inside the electronic device and configured to automatically create a piconet with the first Bluetooth transceiver when the electronic device is activated in the vicinity of the motor vehicle; and,
b. a software program that automatically discontinues the receipt and transmission of text and email messages over the wireless network by the electronic device when a piconet is created between the first Bluetooth transceiver and the second Bluetooth transceiver.

2. A system for automatically controlling the operation of a Bluetooth enabled electronic device when located in the vicinity of a motor vehicle equipped with a Bluetooth transceiver, the system comprising;
a. a motor vehicle;
b. a first Bluetooth transceiver located on or inside the motor vehicle, the first Bluetooth transceiver configured to create a piconet with a second Bluetooth transmitter located in the operational vicinity of the first Bluetooth transceiver;
c. an electronic device with a second Bluetooth transceiver configured to communicate with the first Bluetooth transceiver located in the motor vehicle when the electronic device is located inside the motor vehicle, the second Bluetooth transceiver configured to automatically create a piconet with the first Bluetooth transceiver when electronic device is operated in the operational vicinity of the first Bluetooth transceiver, the electronic device has wireless communication network components that enable the electronic device to receive and transmit voice or data communication signals with a compatible wireless communication network located in the vicinity of the motor vehicle; and,
d. a software program adapted to selectively disable or inactivate the communication network components in the electronic device when a piconet is created between the first Bluetooth transceiver and the second Bluetooth transceiver.

3. The system as recited in claim 1, therein said electronic device includes memory and said software program is loaded into said memory.

4. A method for discontinuing the receipt or transmission of text to and from an electronic device configured to communicate with a nearby wireless communication network while driving a motor vehicle, comprising the following steps:
a. selecting a motor vehicle with a first Bluetooth transceiver located therein, said Bluetooth transceiver configured to communicate with a second Bluetooth transceiver located in a electronic device when the electronic device is in the vicinity of the first Bluetooth receiver and automatically create a piconet between the first Bluetooth transceiver and the second Bluetooth transceiver,
b. selecting an activated electronic device with text message communication capabilities, the electronic device includes a second Bluetooth transceiver adapted to automatically create a piconet with a first Bluetooth transceiver when the electronic device is in the vicinity of the first Bluetooth transceiver, the electronic device also includes a software program that automatically blocks or deactivates the text message communication capabilities of the electronic device with a piconet is created between the first Bluetooth receiver and the second Bluetooth receiver;
c. transporting the electronic device into the motor vehicle to be driven by a user of the electronic device; and,
d. activating the motor vehicle and the first Bluetooth transceiver thereby automatically creating a piconet between the first Bluetooth transceiver and the second Bluetooth transceiver, and blocking or deactivating the text message communication capabilities on the electronic device.
